(19) United States
(12) Patent Application Publication
(10) Pub. No.: US 2025/0111294 A1
(43) Pub. Date: Apr. 3, 2025

(54) Data Vault Methodology for the Management of Decarbonization and Circular Economy

(71) Applicant: Saudi Arabian Oil Company, Dhahran (SA)

(72) Inventors: Faisal F. Alotaibi, Al Jubail (SA); Esra Alhamood, Al Qatif (SA); Rawabi Alkhathlan, Al Khobar (SA)

(21) Appl. No.: 18/477,723

(22) Filed: Sep. 29, 2023

(51) Int. Cl. G06Q 10/0631

(52) U.S. Cl. CPC G06Q 10/0631

(57) ABSTRACT

A computer implemented method that enables a data vault methodology for management of decarbonization and circular economy is described. The method includes obtaining decarbonization data and circular economy data associated with a capital project of an organization in a database and storing the decarbonization data and the circular economy data in a standardized format. The method also includes updating the decarbonization data and the circular economy data of the organization in real time, and transmitting data visualizations of the updated decarbonization data and the updated circular economy data to users over a network in real time.

### TECHNICAL FIELD

This disclosure relates generally to management of decarbonization.

### BACKGROUND

Carbon dioxide (CO2) is the primary greenhouse gas emitted through human activities. CO2 absorbs radiation and prevents heat from escaping from our atmosphere. The high amounts of atmospheric CO2 collects and stores heat and thus, disrupting weather patterns, causing global temperatures to increase and other climate changes.

### SUMMARY

An embodiment described herein provides a method that enables a data vault methodology for management of decarbonization and circular economy. The method includes obtaining, using at least one hardware processor, decarbonization data and circular economy data associated with a capital project of an organization in a database. The method includes storing, using the at least one hardware processor, the decarbonization data and the circular economy data in a standardized format. The method includes updating, using the at least one hardware processor, the decarbonization data and the circular economy data of the organization in real time. The method includes transmitting, using the at least one hardware processor, data visualizations of the updated decarbonization data and the updated circular economy data to users over a network in real time.

An embodiment described herein provides an apparatus comprising a non-transitory, computer readable, storage medium that stores instructions that, when executed by at least one processor, cause the at least one processor to perform operations. The operations include obtaining decarbonization data and circular economy data associated with a capital project of an organization in a database. The operations include storing the decarbonization data and the circular economy data in a standardized format. The operations include updating the decarbonization data and the circular economy data of the organization in real time. The operations include transmitting data visualizations of the updated decarbonization data and the updated circular economy data to users over a network in real time.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include obtaining decarbonization data and circular economy data associated with a capital project of an organization in a database. The operations include storing the decarbonization data and the circular economy data in a standardized format. The operations include updating the decarbonization data and the circular economy data of the organization in real time. The operations include transmitting data visualizations of the updated decarbonization data and the updated circular economy data to users over a network in real time.

In any of the preceding embodiments, the decarbonization data and the circular economy data are standardized to include a source identifier and load date attributes.

In any of the preceding embodiments, users access the updated decarbonization data and the updated circular economy data in the database in real time through a graphical user interface.

In any of the preceding embodiments, the database comprises historical decarbonization data.

In any of the preceding embodiments, the data visualizations comprise an aggregated view of decarbonization data across multiple organization levels.

In any of the preceding embodiments, the decarbonization data and the circular economy data are validated prior to storing the decarbonization data and the circular economy data in a standardized format.

In any of the preceding embodiments, the decarbonization data and the circular economy data are cleaned prior to storing the decarbonization data and the circular economy data in a standardized format.

### BRIEF DESCRIPTION OF DRAWINGS

FIG. 1 shows an architecture that enables a data vault methodology for the management of decarbonization and circular economy.

FIG. 2 shows the architecture of a business intelligence system.

FIG. 3 is a diagram of a workflow that enables a data vault methodology for the management of decarbonization and circular economy associated with a project.

FIG. 4 is a process flow diagram of a process that enables a data vault methodology for the management of decarbonization and circular economy.

FIG. 5 illustrates hydrocarbon production operations that include both one or more field operations and one or more computational operations, which exchange information and control exploration for the production of hydrocarbons.

FIG. 6 is a schematic illustration of an example controller (or control system) for that enables a data vault methodology for the management of decarbonization and circular economy.

### DETAILED DESCRIPTION

A data vault methodology for the management of decarbonization and circular economy is described. Decarbonization data and circular economy data associated with capital projects are validated, approved, and stored in a data vault. Measures of decarbonization are obtained from a variety of sources. In some embodiments, an application system obtains data from users and converts the data to a standardized format, and the standardized data is stored in the data vault. A dashboard system obtains the decarbonization data and circular economy data from the data vault. In some embodiments, the dashboard system enables views of decarbonization data associated with capital projects and equipment across one or more organizations. The dashboard system enables views of decarbonization data at varying levels of granularity. For example, decarbonization data can be viewed for each level, unit, project, division, structure, entity, or other subgroup of an organization that produces carbon emission. Decarbonization data can also be aggregated across multiple organization levels, units, projects, divisions, structures, entities, or other subgroups of an organization. In some embodiments, the dashboard system generates updated views in response to storage of updated decarbonization data or circular economy. In examples, the updated views are transmitted to user displays over a computer network in real time, so that each user has immediate access to up-to-date decarbonization data of an organization at varying levels of granularity. In some examples, based on the immediate access to up-to-date decarbonization data decarbonization data and the circular economy data, an organization can implement efforts to satisfy reductions in carbon emissions or meet regulated decarbonization efforts. Accordingly, in some examples the aggregated decarbonization data drives real-time decarbonization or carbon emission management.

Some advantages of the present techniques include an improvement to decarbonization management by enabling users (including remote users) across an organization to share decarbonization data in a real time standardized format, regardless of the format in which the information was input by the user. The standardized data according to the present techniques enables the creation of an insightful decarbonization tracking and monitoring solution. Further, by observing decarbonization data and circular economy data of capital projects, organizations can comply with regulations and other statutes imposed on carbon emissions prior to operational status of various capital projects, such as the construction of oil and gas facilities and the associated equipment. The present techniques enable a reduction in costs associated with compliance with regulations by capturing early decarbonization data (e.g., prior to operational status of infrastructure) and using the decarbonization data with circular economy data to model decarbonation efforts of an organization.

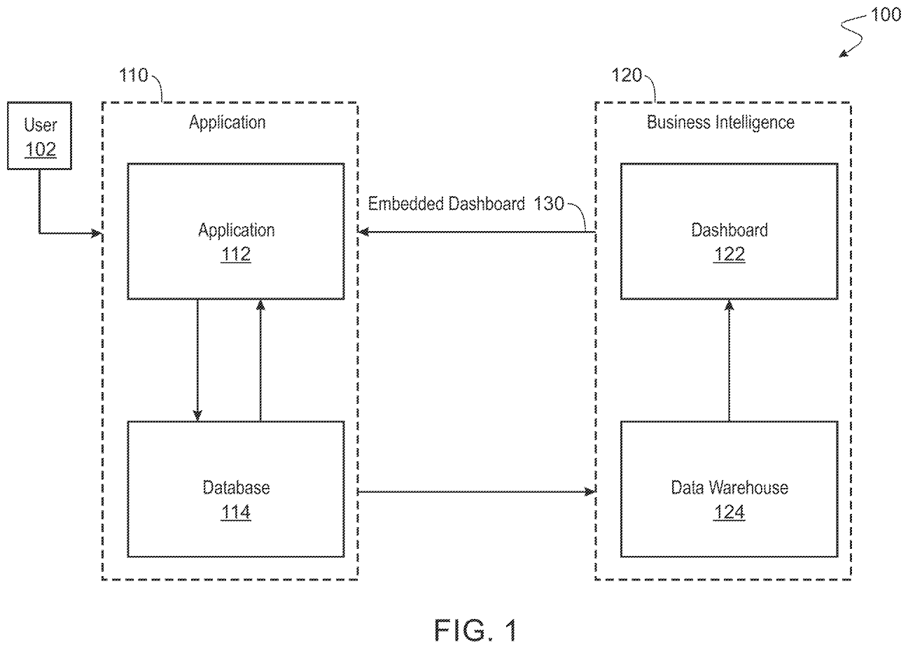

FIG. 1 shows an architecture 100 that enables a data vault methodology for the management of decarbonization and circular economy. The present techniques apply to capital projects, such as those capital projects undertaken prior to facilities being operational, including construction equipment, vehicles, and facilities associated with capital projects. The present techniques specifically target decarbonization associated with the activities of capital projects, such as construction projects, while utilizing business intelligence technologies to track and monitor carbon emissions per project under execution.

Organizations can implement decarbonization efforts to reduce the emission of greenhouse gases (GHG) into the atmosphere, also referred to as carbon emissions. Decarbonization refers to a reduction of carbon intensity or carbon levels in an area or environment. For example, reductions in carbon intensity include lowering the amount of carbon produced by the burning of fossil fuels. In examples, decarbonization is measured as a decrease in CO2 output per unit of electricity generated. Organizations measure, track, monitor, and predict decarbonization data, such as decarbonization levels, such as carbon emissions associated with infrastructure during execution of operations. Infrastructure includes, for example, buildings, facilities, installations, and equipment used by organizations to execute their operations.

In addition to decarbonization data associated with infrastructure, organizations implement capital projects at various levels of the organization that are associated with decarbonization data. For example, during construction of buildings, facilities, installations, and equipment used by organizations to execute operations, decarbonization data is captured. In examples, capital projects are long-term, high-value endeavors with the express purpose of building or improving organizational infrastructure.

As shown in the example of FIG. 1, an architecture 100 includes an application system 110 and a business intelligence system 120. In some embodiments, applications 112 execute processes that enable data collection, data validation, and data processing of decarbonization data associated with capital projects. Applications 112 also implement a hybrid access model of the system. In some embodiments, the hybrid access model is used to determine authorized users based on roles (Data Entry, Reviewer, Approver) and projects (each project team is authorized for input of captured or observed decarbonization data). With this role-based and project-based method, decarbonization data entries for a particular project are input by a Data Entry user from the project team. Reviewing the decarbonization data entries is done by a Reviewer user for that specific project. The decarbonization data entries are approved by an Approver user from the organization handling the project.

In examples, the application is built using a .NET framework. As shown in the example of FIG. 1, the application 112 is communicatively coupled with a database 114. In some embodiments, there are multiple instances of the application 112 executing across an organization. The multiple instances of application 112 execute via respective end devices that access a network of an organization. Using an application 112, a user 102 (e.g., data entry user) can enter decarbonization data for storage in the database 114. In examples, decarbonization data is obtained from multiple sources. A dashboard 122 is associated with the application 112. In examples, a respective dashboard 122 is associated with each instance of an application. The database 114 stores, for example, decarbonization data from multiple sources and circular economy data. In examples, the hybrid access and authorization model constrains the decarbonization data and circular economy data using role-based review.

In examples, decarbonization data refers to data associated with decarbonization efforts of an organization. In examples, decarbonization data, includes, but is not limited to carbon emission quantities, decarbonization quantities, and the like. In examples, the decarbonization data is verified through a review and approval process implemented in a built-in workflow engine implementing the role-based review using the hybrid authorization model. The user 102 can, for example, enter decarbonization data into the database 114 using a graphical user interface (GUI) generated by one or more processes of the application 112. In some embodiments, users are assigned roles and responsibilities associated with entry and reporting of decarbonization data. For example, a data entry user is assigned the role of entering the data associated with capital projects and equipment. Reviewers are users assigned the role of reviewing the entered data for their assigned entities or projects of the organization. Approvers are user assigned the role of approving the reviewed data for their assigned entities or projects of the organization. Once the data is validated and approved, it is stored in the database 114. In examples, the review and approval of entered decarbonization data is an automated process. For example, predetermined thresholds and other evaluations are applied to decarbonization data entered by a user, and decarbonization data that satisfies the predetermined thresholds and other evaluations are stored in the database 112. In some embodiments, the database 114 includes historical decarbonization data from multiple sources. In some embodiments, historical decarbonization data is used to validate and approve data storage in the database 114.

Once the data is validated and approved, a dashboard system 122 obtains the decarbonization using a data vault approach. In examples, the dashboard enables tracking and monitoring of decarbonization data at varying levels of granularity of the organization. The dashboard also enables an aggregated view of decarbonization data through multiple organization levels. In response to the decarbonization data, an organization can implement further efforts to impact carbon emissions or decarbonization efforts.

In some embodiments, the dashboard includes a GUI generated by a data analytics tool comprising project management decarbonization and circular economy key performance indicators (KPIs). The tool provides actionable insights, comparative analysis, and drill-through capabilities. In examples, the data analytics tool is developed according to Power Business Intelligence technology. As shown in the example of FIG. 1, the dashboard is communicatively coupled with a data warehouse 124. In some embodiments, the data warehouse 124 is built for enterprise-scale analytics using a data vault. For example, the data warehouse 124 is a central data warehouse that stores decarbonization and circular economy data according to a data vault (DV) concept. In examples, the data warehouse uses historical decarbonization data from the database 114 to enable a decarbonization model built on a circular economy approach, where each data entry is standardized to include a source identifier and load date attributes, enabling an auditor to trace values back to the source. In this manner, the decarbonization model provides long-term historical storage of data obtained from multiple operational systems. The data is stored to enable auditing, tracing of data, loading speed and resilience to change enabling the ability to trace where all the data in the database came from, resulting in a decarbonization model that is resilient to environmental changes.

The data warehouse 124 includes an architecture for developing an enterprise data warehouse (e.g., big database) for organization that executes agile data analytics and data science projects where scalability, integration with different data sources, development speed and business orientation enabled. The data warehouse obtains decarbonization data and circular economy data that are standardized by the applications 112 and is used by the dashboard systems 122 to track and monitor decarbonization data circular economy data.

Users can provide decarbonization data directly to the database via the application, eliminating the use of non-specific formats of decarbonization data. By eliminating the use of manual spreadsheets, the dashboard system enables consolidation of decarbonization data based on the official organizational structure. Traditionally, decarbonization data is stored at a particular location of an organization, such as at a location associated with management of a capital project. The decarbonization data is often stored in local computers in a non-standard format made available by a hardware or software platform is in use in the particular offices, entities, and equipment associated with capital projects. Traditionally, users enter the decarbonization data for their direct organizations into a spreadsheet in a manual process to track decarbonization data. Manual tracking of decarbonization data does not provide decision makers with a holistic view of their decarbonization status. The present techniques link the consolidated decarbonization data with organizational structure to enable decision makers to view an aggregated view of or drill-down into the details of decarbonization data. For instance, if the decarbonization data was submitted for a lower-level organization (i.e. division), the higher-level organization in the hierarchy (i.e. department) management will be able to view the overall decarbonization status of their departments with the capability of drill-down into the decarbonization status of the divisions.

Often, an organization relies on incomplete decarbonization data stored in varying locations, and decarbonization data that are not timely or readily shared due to format inconsistencies. The present techniques enable a network-based data vault methodology that collects, converts, and consolidates decarbonization data from various entities and equipment associated with organizational capital projects. The decarbonization data is stored in a standardized format on network-based storage devices. In some embodiments, a dashboard system transmits messages notifying users when decarbonization data is updated.

In examples, the decarbonization data and circular economy data are evaluated by a decarbonization model that relies on a circular economy. A circular economy refers to a resource efficient implementation that focuses on closing material and energy loops in order to reduce waste production and resource consumption. Modeling decarbonization efforts using a circular economy enables organizations to implement and update particular decarbonization efforts across the lifecycle of organizational infrastructure. Accordingly, the present techniques obtain decarbonization data and circular economy data when capital projects occur, such as during the construction of facilities. Decarbonization data and circular economy data are also associated with the construction project facilities, equipment, and the like. In some embodiments, the carbon emission/decarbonization data are used to update the decarbonization model.

As shown in the example of FIG. 1, at a high level, the architecture 100 includes a web-based application 110 and a business intelligence solution (interactive dashboard and its associated data warehouse) 120. The capture of decarbonization data associated with capital projects and circular economy data is improved, standardized and optimized. Moreover, the utilization of these technologies added additional capabilities to the solution such as, historical data archiving, data integration, and comparative analysis. In some embodiments, the present techniques combine a data vault methodology, an operating system framework (Microsoft.net) and a scalable intelligent platform (e.g., Power BI) to improve decarbonization modeling within a circular economy. In examples, the data vault methodology enables data validation, collection, and archiving. An operating system framework supports the execution of an application that tracks and monitors carbon emissions and decarbonization efforts during the execution of one or more capital projects. A scalable, intelligent platform computes and aggregates values from carbon emission generated equipment to projects departments. Accordingly, the present techniques are an end-to-end solution that includes a web-based application (.NET framework) and business intelligence solution consisting of a data warehouse utilizing the data vault concept and an interactive dashboard (web-based Power BI dashboard).

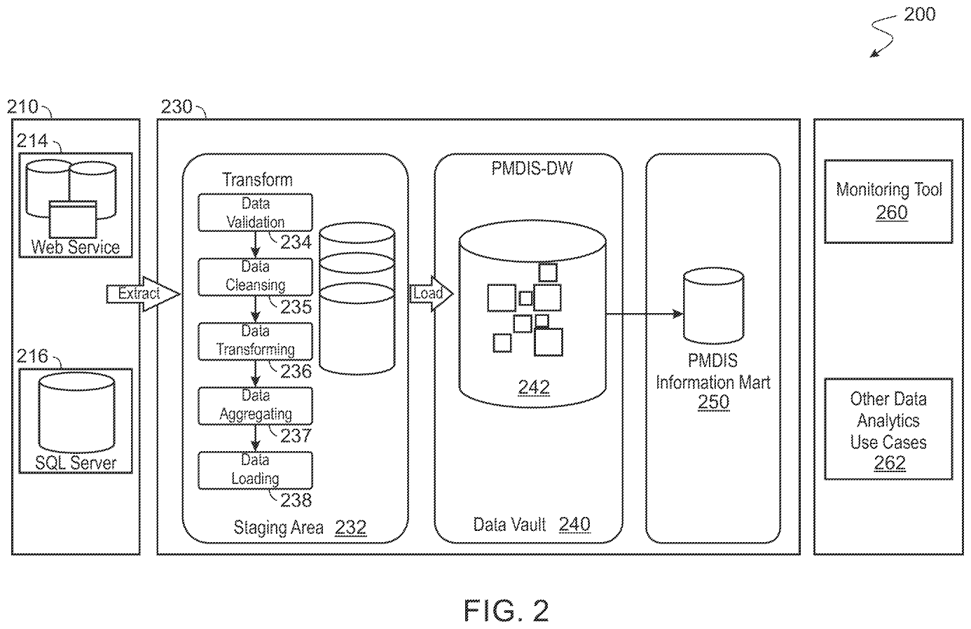

FIG. 2 shows the architecture 200 of a business intelligence system. In some embodiments, the business intelligence system 230 is the same as or similar to the business intelligence system 120 of FIG. 1. The architecture 200 includes databases 210. In some embodiments, data management includes web services 214 and servers 216. The web services are used to retrieve information related to organizational structure, human resources information system (HRIS), and Master Scheduling System (MSS). In examples, the MSS is a corporate system that includes the project information. HRIS is a corporate system that includes user information and organizational structure information. Web services 214 data includes organizational structure data, HRIS data, and MSS data. This information will be part of the data entered by the users. In examples, web services 214 include SAP and Oracle.

In examples, the servers 216 are SQL servers that store and retrieve data as requested by other software applications on the same computer or a remote computer using the client-server model. In some embodiments, the application 112 of FIG. 1 is associated with one or more SQL servers 216 as shown in FIG. 2. The SQL servers 216 store the data coming from the users. In examples, servers 216 include servers that store decarbonization data and circular economy data associated with vehicles, equipment, temporary construction facilities, and KPIs. In examples, servers 216 include servers that store circular economy certifications data and circular economy opportunities, and circular economy implementations. In examples, the business intelligence system 230 obtains data from the databases 210.

In some examples, data stored by the web services 214 and servers 216 are obtained as input from users 102, such as data entry users of an organization that are responsible for entering the data associated with projects. For example, the entered data is input to a staging area 232. In examples, the staging area 232 is an intermediate storage area used for data processing during an extract, transform and load (ETL) process. The data staging area is communicatively coupled with data sources (e.g., databases 210) and the data target (e.g., data vault 240).

Within the staging area, data is preprocessed. At block 234, data validation occurs. In some embodiments, the data validation is an automated input validation based on entry types and values. In some embodiments, data validation includes the review and approval process, where Reviewers are users that review the entered data and Approvers represent users with authority to formally approve the reviewed entries. In examples, the review and approval process is an automated process executed by at least one processor that limits collection of data associated with decarbonization to accurate, precise data, associated with capital projects. The data may be limited by thresholds or according to statistical deviations. At block 235, data cleaning occurs. In examples, data cleaning refers to one or more processes that repair or remove incorrect, corrupted, incorrectly formatted, duplicate, or incomplete data within a dataset. At block 236, data transforming occurs. In examples, transforming refers to the processes and tools that convert raw data into meaningful information to help organizations to make more data-driven decisions. Data transformation process is part of a business intelligence process where the data gets converted from the format of the source system into the required standardized format in order to integrate data form different sources.

At block 237, data aggregating occurs. Data aggregation is part of a business intelligence processes which includes collecting the data from different sources, then organizing and summarizing the data to be converted to visualizations. The data will be visualized in a form of totals and summaries. At block 238, data loading occurs. Pre-preprocessed data is loaded into a project management decarbonization inventory-data warehouse (PMDIS-DW) 242. The PMDIS-DW 242 is the same as, or similar to, the data warehouse 124 of FIG. 1.

In some embodiments, when a user enters decarbonization data or circular economy data, a workflow is triggered where Reviewers will receive submitted decarbonization data entries for their organization. A Reviewer can view, reject, return, or mark the submitted data as reviewed. Reviewed entries can then be approved by an Approver. Approvers are Managers/Directors who are responsible for their organization data reporting. Similar to the Reviewers, Approvers can view, return, reject, or approve the reviewed data. In some embodiments, once approved, the data is loaded into the PMDIS-DW 242. In examples, the PMDIS-DW 242 is built using a data vault methodology 240.

In examples, the data vault methodology 240 includes building a PMDIS-DW 242 which is a central repository that supports business intelligence system activities. A project management decarbonization inventory information mart (PMDIS) 250 enables reading from the data warehouse PMDI-DW 242 and transmitting data to a monitoring tool 260. In some embodiments, star schema data views are sent to the monitoring tool. In a star schema, each dimension table is joined to the fact table through a foreign key relationship. This enables users to query the data in the fact table using attributes from the dimension tables. For example, a user might want to see decarbonization data by project, organizational structure, region, or time period. Other data analytics tool represents implementations derived from the PMDIS-DW 242.

Using the business intelligence system 230, the dashboard (e.g., dashboards 122 of FIG. 2) provides tracking and monitoring of carbon emissions data per project or organization. The dashboards also provide tracking and monitoring of carbon emissions per construction equipment, vehicle, and temporary construction facilities fuel consumption. Additionally, the dashboard provides an aggregated view of decarbonization efforts through multiple organization levels. Traditional manual views of decarbonization through multiple levels of an organization fail to enable an aggregation capability of decarbonization efforts through multiple levels of an organization. Aggregated views enable higher management to have a holistic view of the data.

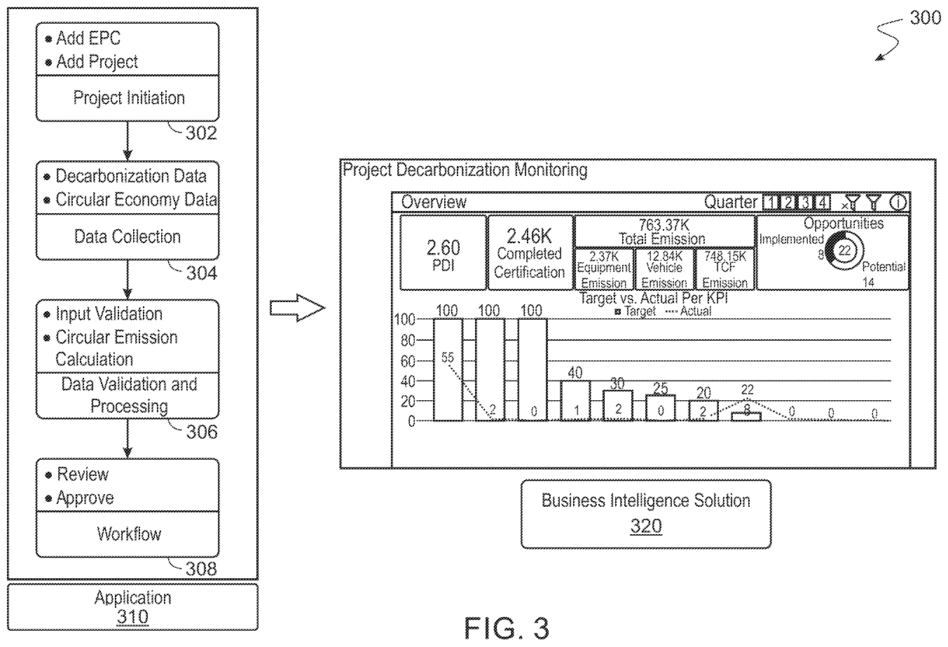

FIG. 3 is a diagram of a workflow 300 that enables a data vault methodology for the management of decarbonization and circular economy associated with a project. In the example of FIG. 3, the application 310 is the same as or similar to the application systems 110 as described with respect to FIG. 1. In the example of FIG. 3, the business intelligence solution 320 is the same as or similar to the business intelligence solution 120 as described with respect to FIG. 1.

At block 302, a project is initiated. In examples, the project is a capital project. Data associated with the capital project, such as engineering, procurement, and construction is defined.

At block 304, data collection is performed. In examples, data collection results in the collection of decarbonization data and circular economy data. In some examples decarbonization data and circular economy data is entered by a user. In some examples, decarbonization data and circular economy data is extracted from databases and historical data.

At block 306, data validation and processing is performed. In some embodiments, data validation includes a review and approval process with multiple users. In some embodiments, data validation includes a automated process where decarbonization data and circular economy data is compared to predetermined thresholds or historical data to validate the data. At block 308, the decarbonization data and circular economy data is reviewed/approved. Based on the approved decarbonization data and circular economy data a business intelligence solution 320 updates a dashboard in real time, providing aggregated decarbonization data and circular economy data to multiple users across a network.

Traditionally, decarbonization data is collected manually and consolidated in spreadsheets stored in various locations by multiple individuals. The present techniques enable a standard, formal entry of decarbonization data. Data entry users are responsible for entering the data for their projects. Reviewers are responsible to review the data entered for projects under their organization. Approvers, which represent authority (i.e. Managers/Directors) formally approve the reviewed entries. Consolidation is handled by the system based on the official organization structure in backbone systems. This eliminates flaws in verifying and consolidating the data in order to ensure correct reporting.

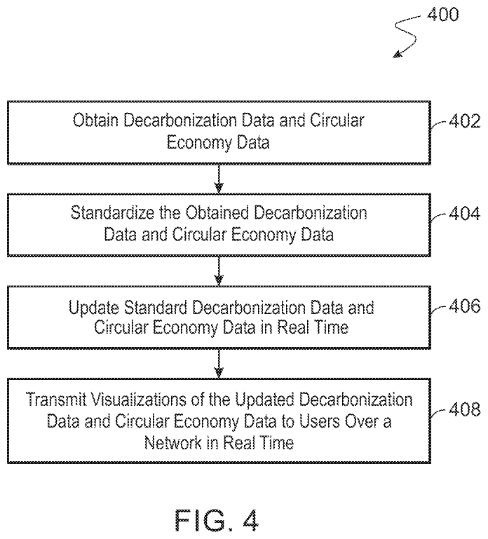

FIG. 4 is a process flow diagram of a process 400 that enables a data vault methodology for the management of decarbonization and circular economy.

At block 402, decarbonization data and circular economy data is obtained. In examples, the decarbonization data quantifies carbon emissions (or a reduction in carbon emissions) associated with a level, unit, project, division, structure, entity, or other subgroup of an organization. In examples, the decarbonization data is stored in network-based non-transitory storage devices having a collection of decarbonization data and circular economy data.

In examples, users enter respective decarbonization data and circular economy data associated with the organization to a database. In examples, the data is stored using networked databases so any one of the users can update the organizations decarbonization data in the collection of decarbonization data and circular economy data in real time through a graphical user interface. In some embodiments, users enter the decarbonization data and circular economy data in a non-standardized format dependent on the hardware and software platform used by the respective users.

At block 404, the decarbonization data and circular economy data are standardized. For example, the data is validated, cleaned, transformed, and aggregated. The standardized decarbonization data and circular economy data is stored in the database in a standardized format.

At block 406, a dashboard system obtains the decarbonization data and circular economy data from the database. In some embodiments, the decarbonization data and circular economy data are standardized so that data entries stored in the database are standardized to include a source identifier and load date attributes, enabling an auditor to trace values back to the source. Based on the standardized data, the dashboard provides the updated decarbonization data and circular economy data to users in real time. In examples, the dashboard generates data visualizations based on messages transmitted to users over the computer network in real time, so that each user has immediate access to decarbonization data and circular economy data.

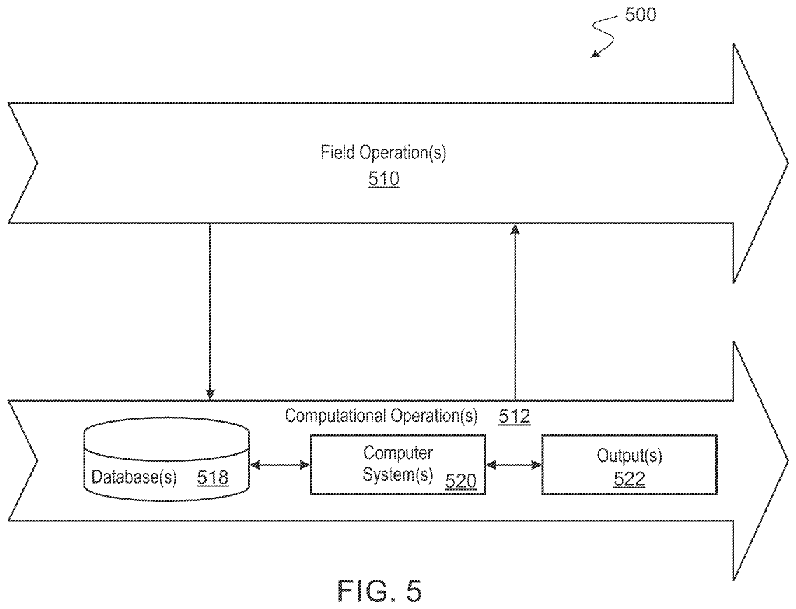

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

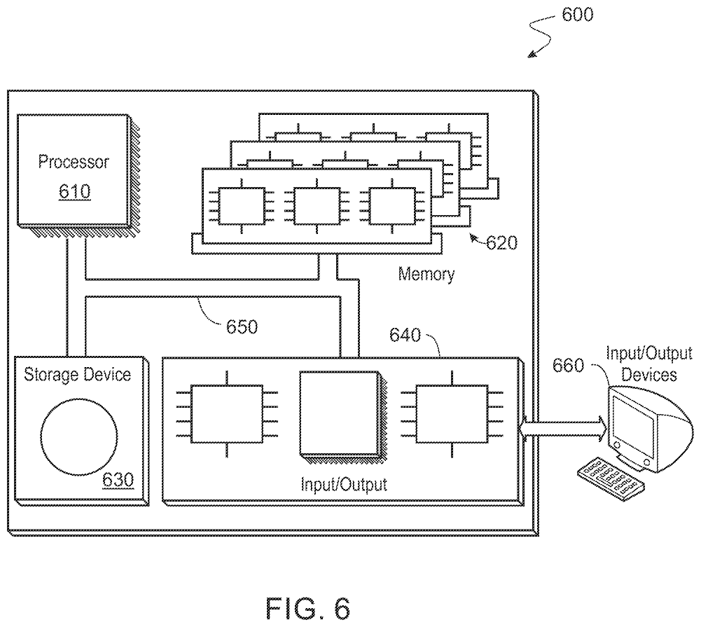

FIG. 6 is a schematic illustration of an example controller 600 (or control system) for that enables a data vault methodology for the management of decarbonization and circular economy. For example, the controller 600 may be operable according to the workflow 300 of FIG. 3 or the process 400 of FIG. 4. The controller 600 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600 and one user can use multiple controllers 600.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables a data vault methodology for management of decarbonization and circular economy, comprising:
obtaining, using at least one hardware processor, decarbonization data and circular economy data associated with a capital project of an organization in a database;
storing, using the at least one hardware processor, the decarbonization data and the circular economy data in a standardized format;
updating, using the at least one hardware processor, the decarbonization data and the circular economy data of the organization in real time; and
transmitting, using the at least one hardware processor, data visualizations of the updated decarbonization data and the updated circular economy data to users over a network in real time.

2. The computer implemented method of claim 1, wherein the decarbonization data and the circular economy data are standardized to include a source identifier and load date attributes.

3. The computer implemented method of claim 1, wherein users access the updated decarbonization data and the updated circular economy data in the database in real time through a graphical user interface.

4. The computer implemented method of claim 1, wherein the database comprises historical decarbonization data.

5. The computer implemented method of claim 1, wherein the data visualizations comprise an aggregated view of decarbonization data across multiple organization levels.

6. The computer implemented method of claim 1, comprising validating the decarbonization data and the circular economy data prior to storing the decarbonization data and the circular economy data in a standardized format.

7. The computer implemented method of claim 1, comprising cleaning the decarbonization data and the circular economy data prior to storing the decarbonization data and the circular economy data in a standardized format.

8. An apparatus comprising a non-transitory, computer readable, storage medium that stores instructions that, when executed by at least one processor, cause the at least one processor to perform operations comprising:
obtaining decarbonization data and circular economy data associated with a capital project of an organization in a database;
storing the decarbonization data and the circular economy data in a standardized format;
updating the decarbonization data and the circular economy data of the organization in real time; and
transmitting data visualizations of the updated decarbonization data and the updated circular economy data to users over a network in real time.

9. The apparatus of claim 8, wherein the decarbonization data and the circular economy data are standardized to include a source identifier and load date attributes.

10. The apparatus of claim 8, wherein users access the updated decarbonization data and the updated circular economy data in the database in real time through a graphical user interface.

11. The apparatus of claim 8, wherein the database comprises historical decarbonization data.

12. The apparatus of claim 8, wherein the data visualizations comprise an aggregated view of decarbonization data across multiple organization levels.

13. The apparatus of claim 8, comprising validating the decarbonization data and the circular economy data prior to storing the decarbonization data and the circular economy data in a standardized format.

14. The apparatus of claim 8, comprising cleaning the decarbonization data and the circular economy data prior to storing the decarbonization data and the circular economy data in a standardized format.

15. A system, comprising:
one or more memory modules;
one or more hardware processors communicably coupled to the one or more memory modules, the one or more hardware processors configured to execute instructions stored on the one or more memory models to perform operations comprising:
obtaining decarbonization data and circular economy data associated with a capital project of an organization in a database;
storing the decarbonization data and the circular economy data in a standardized format;
updating the decarbonization data and the circular economy data of the organization in real time; and
transmitting data visualizations of the updated decarbonization data and the updated circular economy data to users over a network in real time.

16. The system of claim 15, wherein the decarbonization data and the circular economy data are standardized to include a source identifier and load date attributes.

17. The system of claim 15, wherein users access the updated decarbonization data and the updated circular economy data in the database in real time through a graphical user interface.

18. The system of claim 15, wherein the database comprises historical decarbonization data.

19. The system of claim 15, wherein the data visualizations comprise an aggregated view of decarbonization data across multiple organization levels.

20. The system of claim 15, comprising validating the decarbonization data and the circular economy data prior to storing the decarbonization data and the circular economy data in a standardized format.
